(19) United States
(12) Patent Application Publication
(10) Pub. No.: US 2010/0186556 A1
(43) Pub. Date: Jul. 29, 2010

(54) Socket

(76) Inventor: Jack LIN, Taichung City (TW)

Correspondence Address: Dr. BANGER SHIA;Patent Office of Bang Shia, 102 Lindencrest Ct, Sugar Land, TX, 77479-5201, US

(21) Appl. No.: 12/360,921

(22) Filed: Jan. 28, 2009

(51) Int. Cl. B25B 13/06

(52) U.S. Cl. 81/125

(57) ABSTRACT

A socket assembly includes a socket and at least one magnet. The socket includes a polygonal cavity and at least one groove. The polygonal cavity is defined in the socket. The groove is defined in an internal side of the socket. The groove includes an open end. The magnet is slid into the groove from the open end.

### BACKGROUND OF INVENTION

1. Field of Invention

The present invention relates to a socket for use in a socket wrench and, more particularly, to a socket equipped with at least one magnet located near a fastener engaged with the socket.

2. Related Prior Art

Disclosed in Taiwanese Patent No. 397740 is a conventional socket equipped with a magnet. The socket is used together with a handle. The socket and the handle together form a socket wrench. The socket includes a hexagonal cavity for receiving a nut or a head of a screw and a square cavity for receiving a portion of the handle. The magnet is embedded in the bed of the hexagonal cavity. The magnet is used to attract the fastener to keep a nut in the socket before the nut is engaged with a screw or after the nut is disengaged from the screw. The attraction is often inadequate for two reasons. Firstly, the magnet is far from the nut or the head of the screw because the hexagonal cavity is very deep. Secondly, the magnet is small. Moreover, there is a need for a ferrule for keeping the magnet on or in the socket, and a process for equipping the socket with the magnet is complicated, and the cost of the socket is therefore high.

The present invention is therefore intended to obviate or at least alleviate the problems encountered in prior art.

### SUMMARY OF INVENTION

It is the primary objective of the present invention to provide a socket equipped with at least one magnet located near a fastener engaged with the socket.

To achieve the foregoing objective, the socket assembly includes a socket and at least one magnet. The socket includes a polygonal cavity and at least one groove. The polygonal cavity is defined in the socket. The groove is defined in an internal side of the socket. The groove includes an open end. The magnet is slid into the groove from the open end.

Other objectives, advantages and features of the present invention will become apparent from the following description referring to the attached drawings.

### BRIEF DESCRIPTION OF DRAWINGS

The present invention will be described via detailed illustration of three embodiments referring to the drawings.

FIG. 1 is a perspective view of a socket assembly according to the first embodiment of the present invention.

FIG. 2 is a side view of the socket assembly shown in FIG. 1.

FIG. 3 is a front view of the socket assembly shown in FIG. 1.

FIG. 4 is a cross-sectional view of the socket assembly shown in FIG. 1.

FIG. 5 is a side view of a socket assembly according to the second embodiment of the present invention.

FIG. 6 is a perspective view of the socket assembly shown in FIG. 5.

FIG. 7 is a front view of a socket assembly according to the third embodiment of the present invention.

### DETAILED DESCRIPTION OF EMBODIMENTS

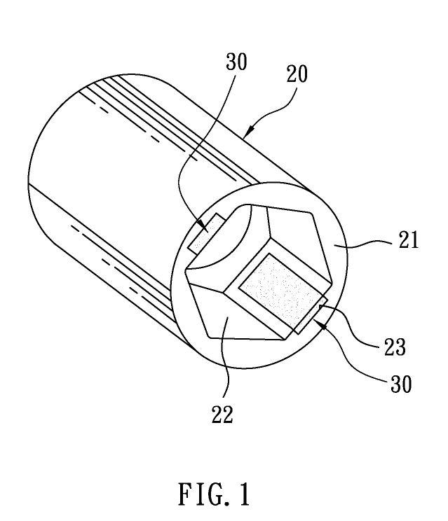

Referring to FIG. 1, a socket assembly includes a socket 20 and two magnets 30 according to a first embodiment of the present invention. The socket 20 includes a cavity 22 defined therein from an end 21. The cavity 22 is preferably hexagonal, i.e., an internal side of the socket 20 includes six facets. A groove 23 is defined in one of the facets while another groove 23 is defined in an opposite one of the facets. The magnets 30 are large.

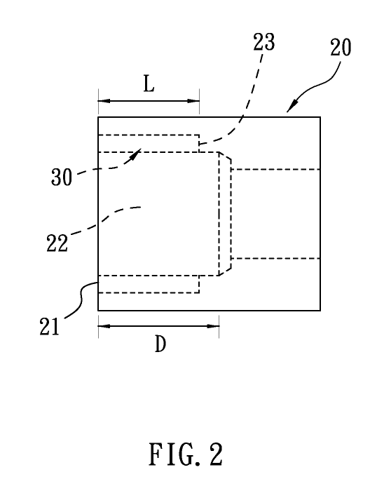

Referring to FIG. 2, a dimension of the cavity 22 along the axis of the socket 20 is smaller than a dimension of the grooves 23 along the axis of the socket 20. Each of the grooves 23 includes an open end and a closed end.

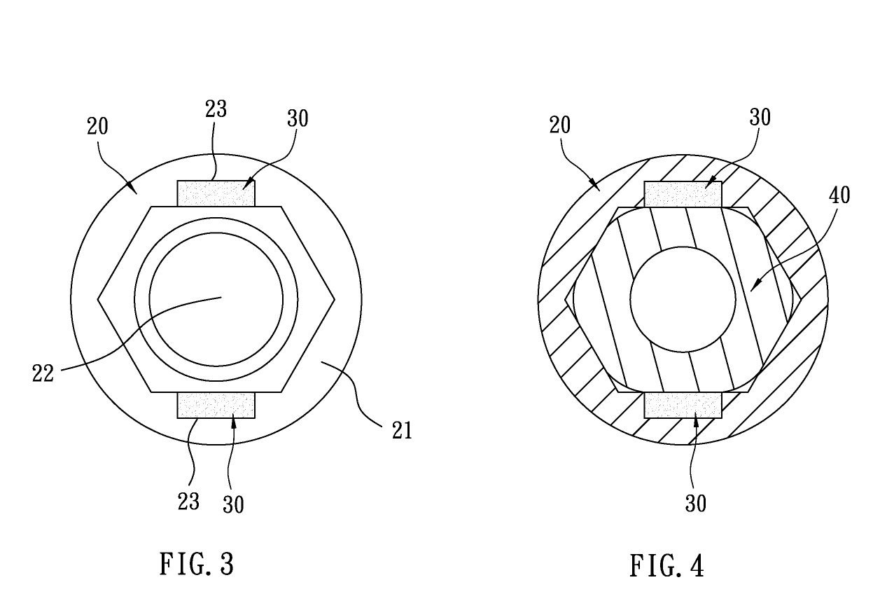

Referring to FIG. 3, each of the magnets 30 is flush with the related facet. Therefore, the magnets 30 do not interfere with smooth insertion of a nut or a head of a screw into the cavity 22.

Referring to FIG. 4, a nut 40 is disposed in the cavity 22. The magnets 30 are close to the nut 40 so that the magnets 30 exert adequate attraction on the nut 40.

The magnets 30 are slid and fit in the grooves 23. The magnets 30 may be made like a dovetail while the grooves 23 may be made like a dovetail groove so that the sliding of the magnets 30 into the grooves 23 is smooth. The equipping of the socket 20 with the magnets 30 is simple, and the cost of the socket assembly is therefore low.

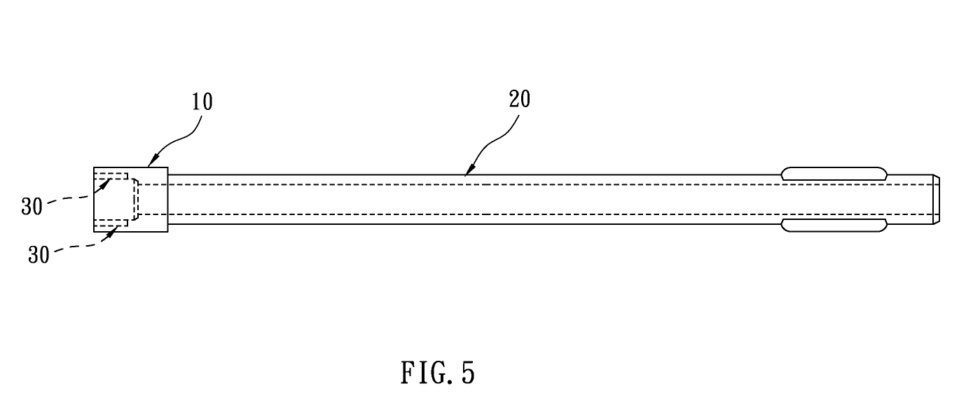

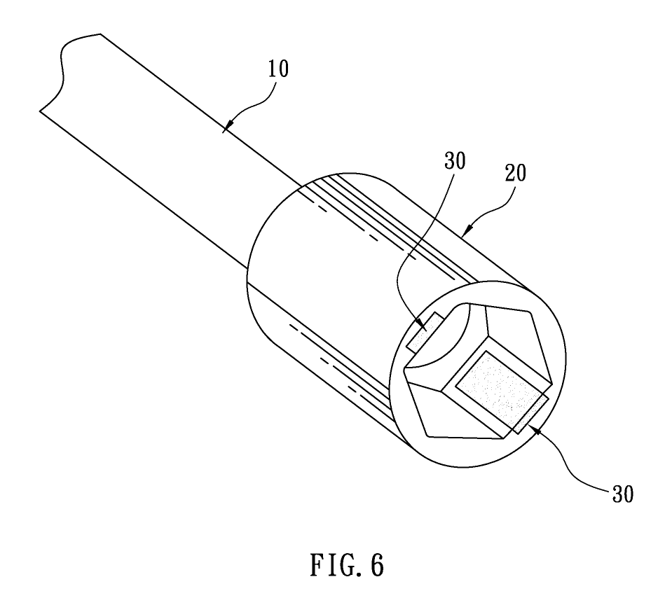

Referring to FIGS. 5 and 6, there is shown a socket assembly according to a second embodiment of the present invention. The second embodiment is like the first embodiment except including an extensive rod 10 extended from the socket 20.

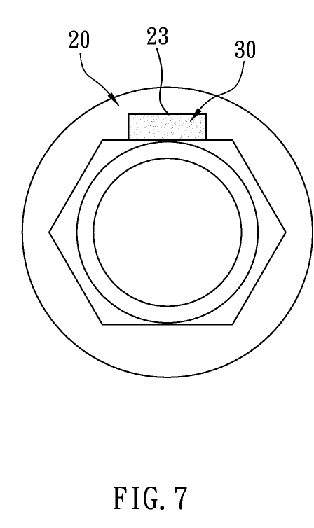

Referring to FIG. 7, there is shown a socket assembly according to a third embodiment of the present invention. The third embodiment is like the first embodiment except including only one magnet 30.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A socket assembly comprising:
a socket comprising a polygonal cavity defined therein from an end and at least one groove defined in an internal side, wherein the groove comprises an open end; and
at least one magnet slid into the groove from the open end.

2. The socket assembly according to claim 1, wherein the socket comprises two grooves for receiving two magnets.

3. The socket assembly according to claim 1, wherein the polygonal cavity extends longer than the groove along the length of the socket.

4. The socket assembly according to claim 1 comprising an extensive rod extended from another end of the socket.
